(19) United States
(12) Patent Application Publication
(10) Pub. No.: US 2010/0017273 A1
(43) Pub. Date: Jan. 21, 2010

(54) Method Apparatus, and System for Grouping Transportation Services

(75) Inventors: Thomas P. Hommrich, Pittsburgh, PA (US); Douglas J. Damico, Bridgeville, PA (US); Jason P. Rushin, Pittsburgh, PA (US); Christopher M. Merchant, Pittsburgh, PA (US)

Correspondence Address: VAN PELT, YI & JAMES LLP, 10050 N. FOOTHILL BLVD #200, CUPERTINO, CA, 95014, US

(73) Assignee: Ariba, Inc.

(21) Appl. No.: 12/586,086

(22) Filed: Sep. 17, 2009

Related U.S. Application Data
(63) Continuation of application No. 09/871,924, filed on Jun. 1, 2001.

(51) Int. Cl. G06Q 30/00; G06Q 99/00; G06Q 50/00; G06Q 10/00

(52) U.S. Cl. 705/10; 705/1; 705/26

(57) ABSTRACT

Grouping transportation lanes is disclosed. Transportation lanes include origination and destination location information, and also have associated values. The grouping includes creating an origination area, creating a destination area, compiling lanes into a lot, and making a determination with respect to the number of carriers available to operate in a lot area.

### CROSS-REFERENCE TO RELATED APPLICATIONS

Not applicable.

### BACKGROUND OF THE INVENTION

1. Field of the Invention

The disclosed invention relates generally to grouping transportation services and identifying potential carriers able to provide such transportation services and in particular, to grouping transportation services and identifying carriers to increase competition and reduce the cost of such transportation services by such carriers.

2. Description of the Background

Procurement of transportation services has traditionally involved a long and tedious, and therefore, costly process. Often, shippers of goods have various locations from where goods are shipped, and a multitude of destinations to where such goods are shipped. Each pair of origination and destination locations defines a transportation lane for which the shipper must engage a carrier. To arrange for shipping of goods, the shipper must identify carriers for each such pair that have the required licenses and permits, that have the appropriate equipment, and are willing to transport the shipper's goods in the lane. When a shipper required transportation services, a buyer for the shipper will typically procure the services by searching for potential carriers and then acquire price quotes from the potential carriers for the needed services. The search for carriers and identification of lanes tends to be inefficient, slow and random, and typically relies heavily on personal relationships because carriers are identified and lanes are developed based on the past experience of the shipper. The costs associated with locating carriers, comparing prices, and negotiating a deal are therefore large, and the search often did not consider all carriers that could provide the services. Because of the inefficiencies involved in identifying carriers and lanes, once a carrier that has provided adequate service is engaged by a shipper, the shipper often continues to use the same carrier rather than incur the cost of locating additional carriers, comparing prices and negotiating other deals with other carriers. As the cost of switching carriers is large, an incumbent carrier may provide pricing that is not the lowest price the carrier could offer because the incumbent carrier recognizes that the buyer will face costs to identify other potential carriers and might not identify all competing carriers.

Therefore, databases of carriers operating in various lanes have been developed. Although such databases aid in the identification of potential carriers to provide transportation services within a lane, such databases do not aid in the comparison of prices offered by various carriers because carrier pricing information, which varies depending on many factors, is not typically included in those databases and because carriers may not be interested in pricing transport of all products or within all locations within their licensed territory. Moreover, carrier bids typically exclude shipments that are less profitable for a particular carrier and accepting a bid for less than all goods to be shipped in a lane leaves certain requirements of a shipper unfulfilled. Further, because carriers know that the prices offered by various carriers for a lane may not include the same requirements and that comparison of bids is therefore difficult, carriers may not offer the most competitive pricing that they could offer, thereby taking advantage of the difficulty of comparison.

Thus, there is a need for a system, apparatus and method whereby a shipper may group transportation requirements such that all bidders are required to bid on the same goods and lanes.

In addition, there is a need for a system, apparatus and method whereby a shipper may identify carriers that are able to provide services in a lane.

There is also a need for a system, a method, and an apparatus that allows a shipper to identify a lane in which a sufficient number of carriers operate so that the bidding for the transportation requirements in such lane is competitive.

### SUMMARY OF THE INVENTION

The present invention is directed to a system, method and apparatus for grouping requirements for transportation services and identifying carriers to provide such transportation services. In accordance with one form of the present invention, there is provided a method of creating a lot containing at least one of a plurality of transportation lanes. In that method, each transportation lane includes an origination location and a destination location and each transportation lane has an associated transport cost. The method includes creating an origination area and a destination area, compiling all lanes having origination locations falling within the origination area and destination locations falling within the destination area, and increasing at least one of the origination area and the destination area of the lot to include more lanes within the lot until the total of the transport cost of all lanes included within the lot exceeds a predetermined amount.

In accordance with another embodiment of the present invention, a method of creating lots containing transportation lanes having at least a minimum number of carriers is provided. In that method, each transportation lane includes an origination location and a destination location and carriers are permitted to operate in limited origination locations and limited destination locations. The method includes creating an origination area encompassing a first geographic area, creating a destination area encompassing a second geographic area, compiling all lanes having origination locations falling within the origination area and destination locations falling within the destination area, and modifying at least one of the first geographic area and the second geographic area to increase the number of carriers that may operate in all lanes included in the origination area and the destination area.

Thus, the present invention provides a method, apparatus, and system whereby a shipper may optimize grouping of shipping requirements into lanes. The present invention also provides a method, apparatus, and system to identify shippers that may transport goods in each of those lanes. Furthermore, the present invention provides a method, apparatus, and system for directly comparing pricing received from various carriers for a lane. In addition, by simultaneously considering the total value of goods to be shipped in a lane, the supply base available to ship goods in that lane, and the competitiveness of those suppliers, the present invention is able to provide a user with groupings of transportation services that are likely to minimize the price of acquiring those transportation services in an online marketplace. Accordingly, the present invention provides solutions to the shortcomings of prior transportation lotting or grouping schemas. Those of ordinary skill in the art will readily appreciate, therefore, that those and other details, features, and advantages will become further apparent in the following detailed description of the preferred embodiments.

### BRIEF DESCRIPTION OF THE DRAWINGS

The accompanying drawings, wherein like reference numerals are employed to designate like parts or steps, are included to provide a further understanding of the invention, are incorporated in and constitute a part of this specification, and illustrate embodiments of the invention that together with the description serve to explain the principles of the invention.

In the drawings:

FIG. 1A is a schematic illustration of the entities involved in an embodiment of an auction wherein the sponsor identifies goods or services to be purchased in a request for quotation;

FIG. 1B is a schematic illustration of entities participating in an embodiment of an auction;

FIG. 1C is a schematic illustration of entities participating in an embodiment of a contract award following an auction;

FIG. 2 is a schematic illustration of communication links between the coordinator, the buyer, and the suppliers in an embodiment of an auction;

FIG. 3 is a schematic illustration of auction software and computers hosting that software in an embodiment of an auction;

FIG. 4 is a schematic illustration of an embodiment of an auction network;

FIG. 5 is a flow diagram illustrating an embodiment of a lotting process of the present invention;

FIG. 6 is a starting screen display of a computer program that may be used to practice an embodiment of the present invention;

FIG. 7 is a city to city lotting screen that may be accessed from the starting screen of FIG. 6;

FIG. 8 is the city to city lotting screen of FIG. 6, illustrating a city pull-down menu;

FIG. 9 is the city to city lotting screen of FIG. 6, illustrating a lane window;

FIG. 10 is the city to city lotting screen of FIG. 6, illustrating a lot naming window;

FIG. 11 is the city to city lotting screen of FIG. 6, illustrating a lot window;

FIG. 12 is the city to city lotting screen of FIG. 6, illustrating the addition of a lane to a lot;

FIG. 13 is the city to city lotting screen of FIG. 6, illustrating the addition of a second lot;

FIG. 14 is the city to city lotting screen of FIG. 6, illustrating a lot detail window;

FIG. 15 is a city to state lotting screen that may be accessed from the starting screen of FIG. 6;

FIG. 16 is the city to state lotting screen of FIG. 15, illustrating an origination city to multiple state lotting facility;

FIG. 17 is the city to state lotting screen of FIG. 15, illustrating a view current lot window;

FIG. 18 is the city to state lotting screen of FIG. 15, illustrating an origination city to region lotting facility;

FIG. 19 is a state to state lotting screen that may be accessed from the starting screen of FIG. 6;

FIG. 20 is the state to state lotting screen of FIG. 19, illustrating an origination state to multiple state lotting facility;

FIG. 21 is an outreach screen that may be accessed from the starting screen of FIG. 6; and

FIG. 22 is the outreach screen of FIG. 21, illustrating a carrier window.

### DETAILED DESCRIPTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical bidding systems and computer networks.

In a supplier-bidding auction or reverse auction, bids, which are often in the form of a price quote, typically start high and move downward over time as bidders interact to establish a closing price. Typically, the auction marketplace is one-sided, with one buyer and many potential suppliers, although multiple-buyer auctions are possible. Typically, products are purchased in the form of components or materials. In the present invention, the auction marketplace would typically be directed to auctioning transportation of such products.

Industrial buyers do not typically purchase transportation services for one product at a time. Rather, they tend to purchase service for all predicted transportation needs for a particular transportation lane over a period of time. Therefore, in a typical transportation-bidding auction, transportation of goods in adjacent lanes may be grouped together in “lots” for pricing or bidding. In a regular lot bidding auction, each lot is composed of several “line items.” In the regular lot bidding auction, the suppliers bid on each line item and a bidder 30 having the best bid for all of the lanes in the lot is the best bidder 30. The best bidder 30 is typically awarded a contract to supply all of the transportation services in the lot. In an aggregate type lot bid, a single bid for all of the line items is submitted by each bidder 30 and the bidder 30 submitting the lowest aggregate price is the best bidder 30. By lotting transportation services, potential suppliers can bid on lots for which they are best suited or in territories in which they are permitted to operate, and are not typically required to bid on every lot. Such a division into lots beneficially reduces the barrier to entry for new potential suppliers that only have capability to supply some of the needed transportation services in the auction. Reducing the barrier to entry also benefits the purchaser by injecting additional bidders 30 into bidding for certain lots.

Typically, transportation lanes in a lot are related to one another such that it is more efficient to have a supplier provide all of the transportation services in that lot. As an example, a shipper might purchase transportation services from a particular plant or distribution center to a variety of customers located in a particular geographic area. Those lanes may be created such that they are so closely related that it is nearly always more efficient to purchase services in those related lanes from the same carrier. Thus, such related lanes are typically grouped in a single “lot.”

While it is good to have multiple suppliers bidding on, or providing pricing for, a given lot, it is also important to consider the overall competitiveness of each supplier. By considering multiple variables surrounding a supplier's participation in past bidding or sale events, it is possible to assign each supplier a relative competitiveness score. Factors that may be used to calculate that score include, for example, the number of prior events a supplier has participated in and the amount of discount they delivered to the buyer in those events. By looking at, for example, an average score for each supplier in conjunction with the total number of suppliers that are likely to participate in an event, a user of the present invention may forecast its ability to successfully arrange for the purchase of a particular group of transportation services.

By establishing minimum thresholds such as, for example, a number of suppliers, an average competitive ranking for each supplier and a desired number of lots, possibly with a maximum number of lots, a user may automate the process of creating lots.

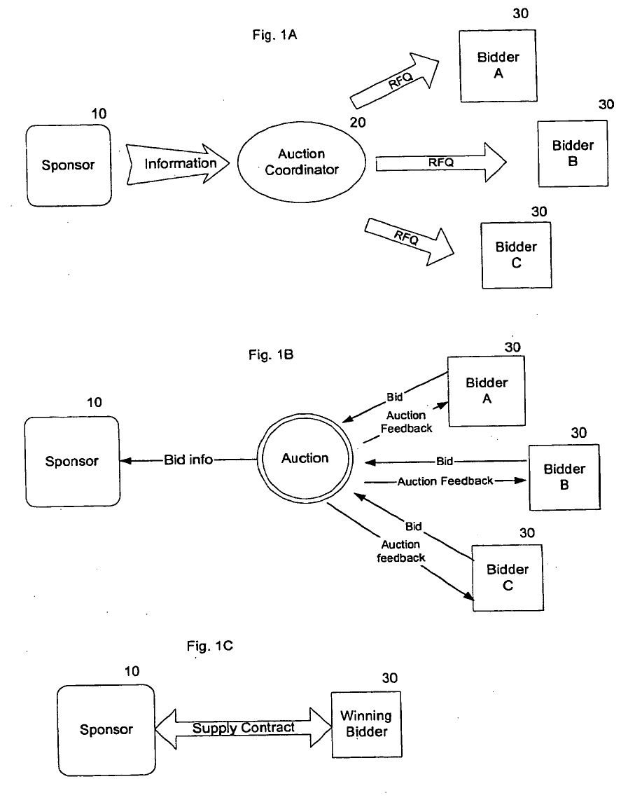

The basic process for a purchaser sponsored supplier-bidding or reverse auction, as conducted by the assignee of the present invention, is described below with reference to FIG. 1. FIG. 1 illustrates the functional elements and entities involved in setting up and conducting a typical supplier-bidding auction. FIG. 1A illustrates the creation of an auctioning event, FIG. 1B illustrates the bidding during an auction, and FIG. 1C illustrates results after completion of a successful auction.

As will be apparent to one skilled in the art, while the invention is generally described in terms of one buyer and multiple suppliers, the present invention may also be used in other types of electronic markets, such as auctions having multiple potential buyers and sellers, forward auctions having a single seller and multiple potential purchasers, upward-bidding auctions, or electronic exchange marketplaces. The term “sponsor” will be utilized herein to identify the party or parties that originate the auction. In a forward auction, for example, the sponsor would typically be the supplier or seller of one or more goods or services. In such a forward auction, that sponsor might state a good that it desires to sell and receive bids from parties wishing to purchase that good. Those parties wishing to purchase that good would furthermore be “bidders” 30 in such a forward auction.

In a reverse auction example, the sponsor would typically be the purchaser or buyer of one or more goods or services. In such a reverse auction, that supplier might state a good that it desires to purchase and receive bids from parties wishing to supply that good. Those parties wishing to supply that good would furthermore be “bidders” 30 in such a reverse auction.

In the typical supplier-bidding reverse auction model, the product or service to be purchased is usually defined by the sponsor of the auction. As shown in FIG. 1A, when a sponsor 10 decides to use the auctioning system of the present invention to procure products or services, the sponsor 10 provides information to an auction coordinator 20. That information may include information about incumbent suppliers and historic prices paid for the products or services to be auctioned, for example. Typically, the sponsor 10 may also work with the auction coordinator 20 to define the products and services to be purchased in the auction and, if desired, lot the products and services appropriately so that needed products and services can be procured using optimal auction dynamics. A specification may then be prepared for each desired product or service, and a Request for Quotation (“RFQ”) generated for the auction.

Next, the auction coordinator 20 typically identifies potential suppliers, preferably with input from the sponsor 10, and invites the potential suppliers to participate in the upcoming auction. The suppliers that are selected to participate in the auction become bidders 30 and may be given access to the RFQ, typically through an RFQ in a tangible form, such as on paper or in an electronic format.

As shown in FIG. 1B, during a typical auction, bids are made for lots. Bidders 30 may submit actual unit prices for all line items within a lot, however, the competition in an auction is typically based on the aggregate value bid for all line items within a lot. The aggregate value bid for a lot may, therefore, depend on the level and mix of line item bids and the quantity of goods or services, such as the quantity of goods to be shipped in a lane, that are offered for each line item. Thus, bidders 30 submitting bids at the line item level may actually be competing on the lot level. During the auction, the sponsor 10 can typically monitor the bidding as it occurs. Bidders 30 may also be given market feedback during the auction so that they may bid competitively.

Feedback, including bidder 30 identity, and information pertaining to bidding activity is referred to as “market feedback” and includes any information or data related to the bidders 30 or their bids, interrelationships between those bids, and any other bid related information or data that is received before or during the auction. Market feedback may include, for example, bids that have been placed by other bidders 30, the rank of a participants bid in relation to one or more other bidders 30, the identity of bidders 30, or any subset of that information. Market feedback may also include non-pricing information such as, for example, the quality of the goods to be provided by bidders 30 and shipping costs associated with one or more bidders 30. Providing such market feedback to bidders 30 in an auction helps create real-time competitive interaction among participants in the auction because, without feedback, bidders 30 who are not leading in an auction might not be aware or their relative position and would have less incentive to revise their price quotes and place additional bids to remain competitive.

After the auction, the auction coordinator 20 may analyze the auction results with the sponsor 10. The sponsor 10 typically conducts final qualification of the low bidding supplier or suppliers 30. The sponsor 10 may furthermore retain the right not to award business to a low bidding supplier 30 based on final qualification or other business concerns. As shown in FIG. 1C, at least one supply contract is usually drawn up and executed based on the results of the auction.

The auction may be conducted electronically between bidders 30 at their respective remote sites and the auction coordinator 20 at its site. In an alternative embodiment, instead of the auction coordinator 20 managing the auction at its site, the sponsor 10 may perform auction coordinator tasks at its site.

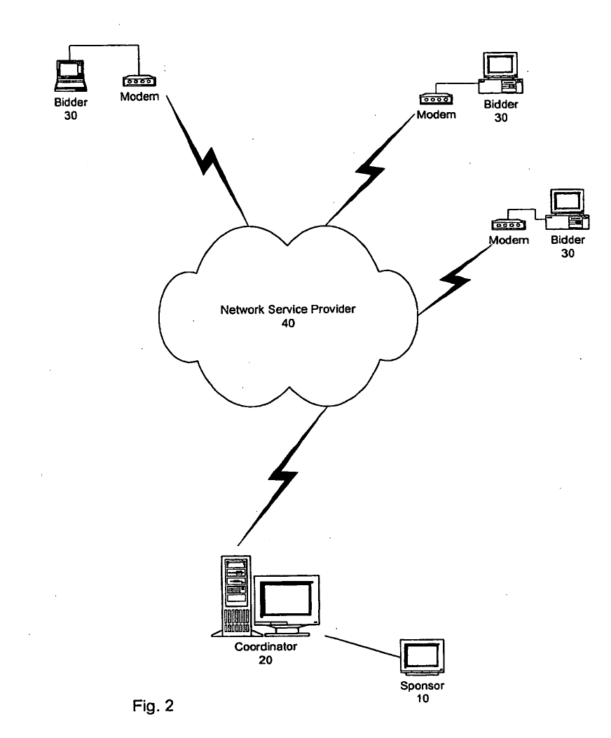

Information may be conveyed between the coordinator 20 and the bidders 30 via any known communications medium. As shown in FIG. 2, bidders 30 may be connected to the auction through the Internet via a network service provider 40 accessed, for example, through a dial-up telephone connection. Alternately, sponsors 10 and bidders 30 may be coupled to the auction by communicating directly with the auction coordinator 20 through a public switched telephone network, a wireless network, or any other known connection method. Other methods of connecting sponsors 10 and bidder 30 and other communications mediums are known to those skilled in the art, and are intended to be included within the scope of the present invention.

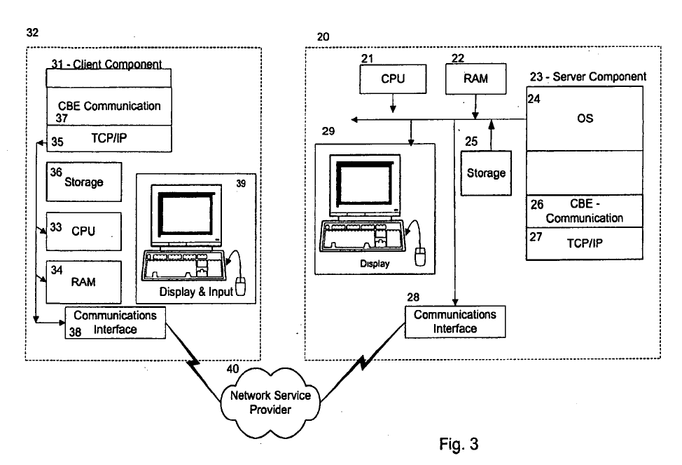

A computer software application may be used to manage the auction. The software application may include two components: a client component 31 and a server component 23. FIG. 3 illustrates the server component 23 and the client component 31 resident in host computers in a first embodiment. As may be seen in FIG. 3, the server component 23 of that embodiment includes an operating system 24, competitive bidding event or auction communication software 26, and Internet protocol software 27. The server software is hosted on a computer 32 having a processor 21, random access memory 22, and a data storage facility 36. The host computer 32 also includes input and output devices 29 such as, for example, a monitor, printer, mouse and keyboard, and a communications interface 28 for communicating with the client component 31. The client component 31 of the embodiment illustrated in FIG. 3, includes competitive bidding event communication software 37, and Internet protocol software 35. The client component software is hosted on a computer 32 having a processor 33, random access memory 34, and the data storage facility 36. The host computer 32 also includes input and output devices 39 such as, for example, a monitor, printer, mouse and keyboard, and a communications interface 38 for communicating with the server component 23.

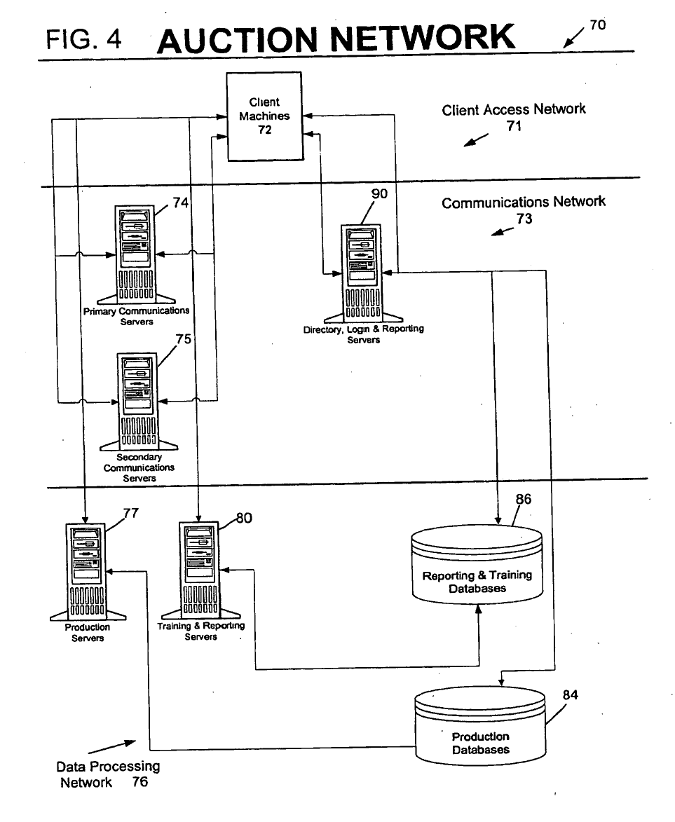

The client component 31 is used by the bidders 30 to make bids during the auction, and to receive and display feedback from the auction. The client component may, for example, be a program that is installed on a bidder's computer, or it may be software that is accessed and run from a Website. Bids can typically only be submitted using the client component of the application, thereby ensuring that sponsors 10 cannot circumvent the bidding process, and that only invited suppliers 30 participate in the bidding. Each computer software application may be stored in a data storage device and executed by a processor such as those described in connection with FIG. 4 hereinbelow.

Bids are sent over the communications medium to, for example, the auction coordinator, or where the sponsor 10 is performing auction coordination tasks, directly to the sponsor 10. Bids are received by the server component 23. The client component includes software functions for making a connection over the Internet, or other medium, to the server component. Bids are submitted over this connection and feedback is sent to connected bidders 30.

When a bidder 30 submits a bid, that bid is sent to the server component and evaluated to determine whether it is a valid or acceptable bid. Feedback about received bids is sent to connected bidders 30 as is applicable, enabling bidders 30 receiving feedback to see changes in market conditions and plan competitive responses.

The embodiments described herein utilize an online reverse auction, wherein the present invention is performed by a computer processor, as an example in which the present invention may be utilized. In those examples, suppliers 30 bid to supply goods or services to the sponsoring purchaser 10 and the purchaser 10 typically purchases the goods or services from the lowest priced qualified bidder 30. It is to be understood, however, that the present invention may be used in other applications, would not necessarily have to occur online, and may be performed by other than a computer processor. The present invention may also be utilized in connection with auctions other than reverse auctions. For example, the present invention may be advantageously utilized with forward auctions, wherein the party offering the highest priced qualified bid, rather than the lowest priced qualified bid, is awarded the goods or services being sold. In the case of a forward auction, the “leading bid” is the highest amount offered and the leading bidder 30 is the purchaser party 10 making that highest offer, while in a reverse auction, the “leading bid” is the lowest amount offered and the leading bidder 30 is the supplier party 30 making that lowest bid. Similarly, placing a “better bid” in a reverse auction indicates placing a lower bid, while placing a “better bid” in a forward auction indicates placing a higher bid.

FIG. 4 is a diagram illustrating an auction network 70 of the present invention for operating an auction, and into which the server component 23 and client component 31 may be incorporated. The auction network 70 may be divided into three functional sections: a client access network 71, a communications network 73, and a data processing network 76. The client access network 71 may, for example, include one or more client machines 72 for accessing and communicating with the communications network 73. The communications network 73 may include one or more primary communications servers 74, secondary communications servers 75, and directory, login and reporting servers 90. The data processing network 76 may include production servers 77, training and reporting servers 80, reporting and training databases 86, and production databases 84. The production servers 77 and training and reporting servers 80 are referred to collectively herein as bid servers 77 and 80.

The client machines 72 may be, for example, personal computers and may be located at each bidder 30 and sponsor site 10 for accessing the auction. The client machines 72 may access the auction by, for example, connecting to a web site operated by the party hosting the auction. The client machines 72 may also receive software from the communications network 73 that facilitates communications with the communications network 73. Each client machine 72 may have a processor that executes applicable software, and a data storage device that stores applicable software and other auction data.

The primary communications servers 74 are utilized to provide information to bids 58 received from the client machines 72 to the bid servers 77 and 80, and to provide that bid information from the bid servers 77 and 80 to the client machines 72. The primary communications servers 74 may furthermore act as a firewall to prevent direct access to the bid servers 77 and 80 by the client machines. The secondary communications servers 75 act as backups to the primary communications servers 74. The secondary communications servers 75 will perform the communication functions normally performed by the primary communications servers 74 if a failure occurs in the primary communications servers 74, thereby providing redundancy to the auction network 70.

The directory, login, and reporting servers 90 may perform a variety of functions that may be performed by a single server or include separate servers for the various functions. The directory, login, and reporting servers 90 may include a web server that acts as a portal for access to the auction network 70. As such, the directory, login, and reporting servers 90 will receive login requests for access to the auction network 70 via, for example, the Internet. The directory, login, and reporting servers 90 may make access decisions as to whether a client machine 72 is permitted to access the communications network 73. If access is permitted, the directory, login, and reporting servers 90 will direct the client machine 72 to the appropriate portion of the auction network 70. The directory, login, and reporting servers 90, may provide reports to client machines 72. For example, information from prior auctions which may be utilized by purchasers 10 to make a decision as to which bidder 30 will be awarded the sale and to permit the purchaser 10 to consider the way in which the auction proceeded so that future auctions may be refined.

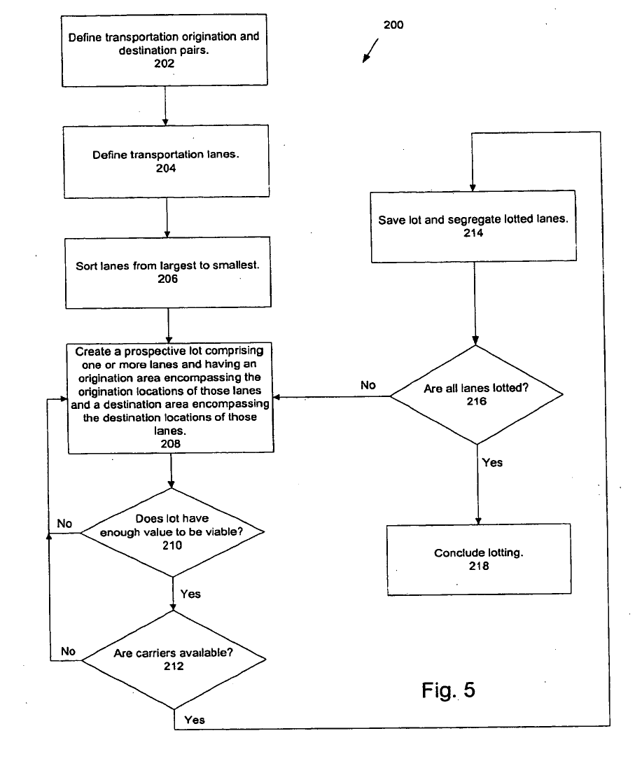

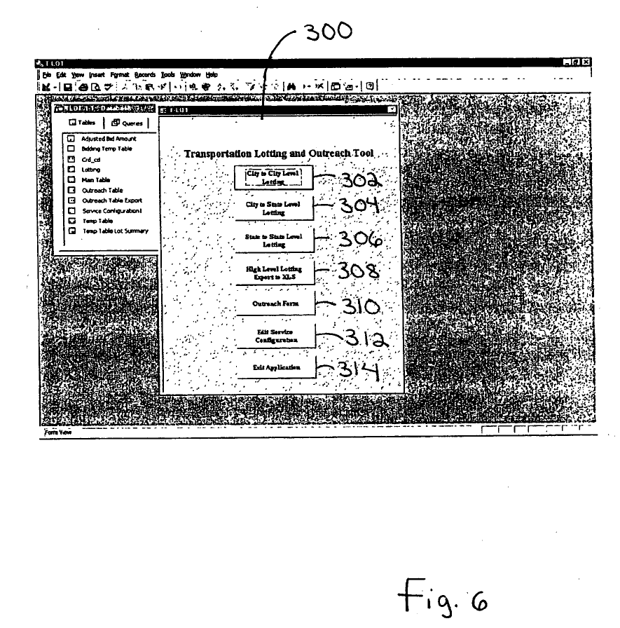

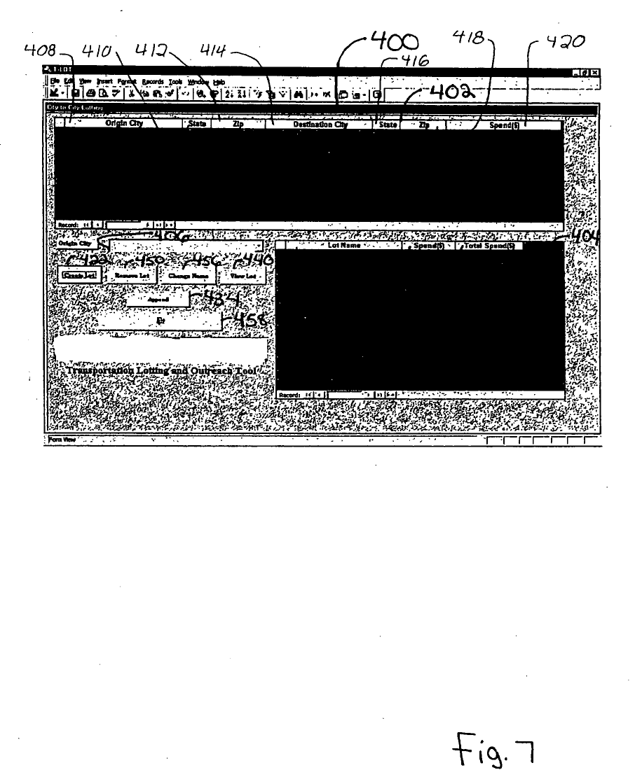

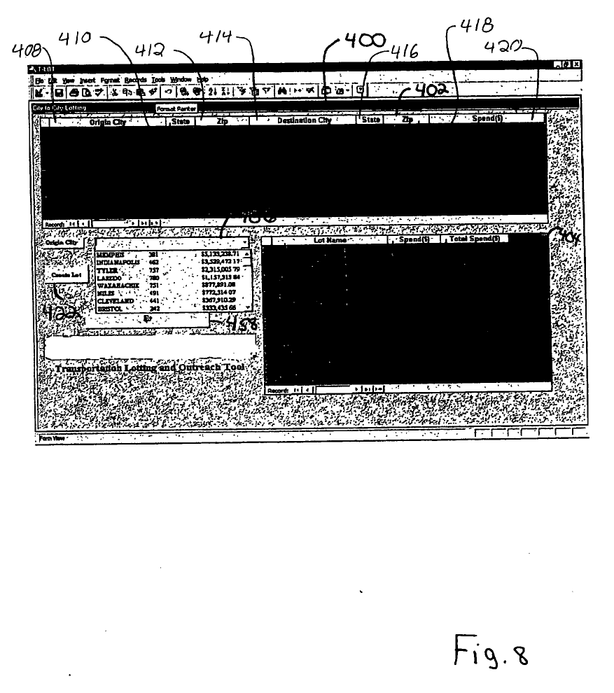

The production servers 77 run the bidding software that facilitates the auction process such as, for example, the software illustrated in FIGS. 5, 6 and 7. The production servers 77 may communicate with client machines 72 through primary and secondary communications servers 74 and 75. The production servers 77 may also be redundant so that if a failure occurs in the production server 77 that is being utilized in an auction event, the redundant backup production server 77 may perform the functions of the failed production server 77 and thus, prevent failure of the auction.

The training and reporting servers 80 operate in a manner similar to the production servers 77 and provide reports for auctions. It is useful to operate test auctions to test the operating systems and to train personnel and clients. Such testing may be performed on the production servers 77 or, to prevent any degradation of system operation in actual auctions, one or more separate training servers may be utilized for testing and training. Reporting may also be accomplished on the production servers 77 or the report creation functions may be offloaded to one or more reporting servers 80. The reporting servers 80 may furthermore be combined with the training servers 80.

Each server 74, 75, 77, 80, and 90 may have a processor that executes applicable software, and a data storage device that stores applicable software and data. It should be noted that, although the present invention is described in terms of a server component and a client component, one skilled in the art will understand that the present invention is not limited to a client/server program relationship model, and may be implemented in a peer-to-peer communications model or any other model known to those skilled in the art.

Data related to auctions may furthermore be held in one or more storage devices. The data storage devices may, for example, be a magnetic storage device, a random access memory device (RAM), or a read only memory device (ROM). The data may include pre-auction data, post auction data, and data that is related to active auctions. Pre-auction data may include, for example, suppliers 30 that are permitted to bid on a particular auction and the scheduled auction starting and ending times. Post auction data may include the bids and bid times received in a particular auction and reports displaying that data in user friendly formats. Active auction data may include data received from the bidders 30 as the auction is taking place and related data such as the rank of each bidder 30.

The “rank” of the bidders 30 is generally determined by comparing the lowest amount bid by each bidder 30 and ordering the bidders 30 according to those lowest bids. The bidder 30 ranked first is the bidder 30 that has bid an amount lower than any other bidder 30 in a reverse auction. The last rank may be a rank equal to the number of bidders 30 who have submitted bids in the auction. In the case of tie bids between bidders, the last rank may be a rank equal to the number of unique bids by each bidder. In a reverse auction based on price only, the bidder 30 having that last rank is the bidder 30 that has submitted the highest amount.

Of course, there are many known ways to calculate rank, and any of those may be used in connection with the subject invention, and are intended to be within the scope of the present invention. The bidders 30 are generally ranked between first and last according to the amounts of their lowest submitted bids in a reverse auction. Thus, a higher, or better ranked bidder 30 in a reverse auction is a bidder 30 who has placed a comparatively lower bid, while a higher, or better ranked bidder 30 in a forward auction is a bidder 30 who has placed a comparatively higher bid.

An auction may alternately be based on one or more factors other than price, such as quality, delivery factors, and/or other factors that are referred to herein collectively as “total value.” Thus, rank may also be based on factors other than price, including total value and any other factor that is useful in an auction setting. A bid or bid amount is a value that is submitted by each participating bidder 30 for comparison to the bids of other bidders 30, and may likewise be based on a variety of bid factors that are considered important to the bid participants. Those factors may include, for example, price, quality, other costs such as delivery costs, or a total value. Bids may also be placed in a number of ways including, for example, absolute total value, or comparative value such as bidding in relation to an index price.

Three databases, or groupings of databases, are incorporated into the auction network illustrated in FIG. 4. The production databases 84 hold data that will be used by or is received from the production servers 77, while the reporting and training databases 86 hold data that will be used by or is received from the training and reporting servers 80.

The directory, login, and reporting servers 90 illustrated provide a web portal for the client machines 72. The directory, login, and reporting servers 90 provide an initial contact point for the client machines 72, access to auctions in which the client machine 72 is permitted to participate, and reports relating to active and closed auctions.

One skilled in the art will recognize that certain components of the network described herein, while beneficial to an auction network, are not necessary components in an operational auction network. For example, the secondary communications servers 75 could be removed where the benefit of redundancy is not desired, and the primary communications servers 74 could be removed and the client machines 72 could communicate directly with the bid servers 77 and 80.

FIG. 5 is a flow diagram 200 illustrating an embodiment of the present invention in which lots, or economically viable groupings of transportation services are created. The lots are created in a way that optimizes the quantity of goods to be transported and the number of carriers that may provide the services encompassed by that lot, while minimizing the geographic area encompassed by the lot. The method described in connection with FIG. 5 may be implemented on the auction network illustrated in FIG. 4 and in accordance with the auction strategy described in connection with FIGS. 1-3.

At 202 a plurality of sets of transportation pairs are defined. Each transportation pair includes an origination location from which goods are to be transported and a destination location to which those goods are to be transported. The location may be a specific dock, a building, or a general area. At 204, transportation lanes are defined by the transportation pairs. Thus, a transportation lane includes an origination location, a destination location, and optionally, any route by which goods may be transported between the origination location and the destination location. A route may, for example, include highway routes for truck transport, rail lines for rail transport, sea routes for shipping by ship, air routes for airfreight, or any combination of those forms of transport or any other form of transport.

Transportation services may be purchased for shipments expected over a period of time in one or more lanes. Alternately, rates for transportation services may be negotiated through, for example, an on-line auction for such shipping needs. For example, a shipper may desire to purchase all shipping needs for a year in advance. The shipper may furthermore determine approximate shipping needs for that future year by analyzing current and expected contracts involving shipments and predicting the amount of shipping required for each of those. Particularly for shipping merchants that have similar shipping needs from year to year, historic shipping requirements over the past year or more may provide a close estimate of shipping needs over the future period over which transportation services are desired to be purchased. Thus, future transportation needs may be estimated by analyzing, for example, amounts of goods shipped from an origination location to a destination location or number of dollars spent to ship goods from an origination location to a destination location.

At 206, the lanes are sorted in descending order of activity with the most active lane, as determined, for example, by quantity of goods shipped in the lane or quantity of dollars spent shipping in that lane, listed first. Thus, for example, the lane in which the greatest number of transportation dollars are expected to be spent may be listed first and the lane in which the fewest number of transportation dollars are expected to be spent may be listed last.

At 208, related lanes are combined into a lot or a large lane may be assigned a lot of its own. A lot, therefore, includes the amount of goods to be shipped in the lanes included in the lot, which may be represented by an estimated value of transporting those goods, and origination and destination areas that encompass the origination and destination locations of each lane in the lot. Lot origination and destination areas having various sizes may be formed to provide a comparison of how lanes may be optimized by combining them into various lots such that the most cost-effective combinations may be created to reduce transportation costs for the shipping merchant. Efficient lots may then be amalgamated to form a structure from which, for example, transportation services may be purchased through an on-line auction. Efficient lots may have various characteristics and those characteristics may conflict. For example, an efficient transportation lot may include lanes in which a large quantity of goods are transported and that are in close geographic proximity. Thus, the desire to include a large quantity of goods in a lot may drive a purchasing shipper to increase the geographic area encompassed by a lot. Conversely, the desire to reduce the geographic area through which a carrier must travel may drive a shipper to reduce the number of origination or destination locations in a lot, thereby reducing the quantity of goods to be shipped in that lot. The present invention assists those who desire to create lots in balancing such conflicting characteristics by illustrating potential lots of varying sizes for consideration. For example, the present invention may combine lanes having origination locations within a particular city and destination locations within a particular city into prospective lots for consideration by the user. Similarly, lanes having origination locations within a particular state and destination locations within a particular state may be combined into prospective lots for consideration by the user. It will be recognized that lanes having origination locations falling within any geographic region and destination locations falling within any geographic region may be combined by the present invention. The present invention may achieve efficient lot creation by, for example, having a user step through various levels of geographic lotting areas and thereby creating efficient lots or by permitting a user to enter predetermined lotting criteria and allowing the present invention to automatically create suitable lots. Thus, the present invention endeavors to create a balance between factors including the geographic area encompassed by origination and destination areas, the number and quality of transportation service providers available to service that area, and providing an economically sufficient quantity of transportation needs to promote supplier interest to achieve competitive pricing in, for example, an on-line auction. In any case, the present invention may recognize a lot that is economically viable and has a good supply base and either recommend against creation of that lot or completely disallow creation of that lot due, for example, to poor past performance from the identified supplier base.

A user, such as a shipping merchant or representative thereof, may analyze the lanes individually and in combination, for example, by destination city and destination state. Thus, in one level of analysis, the lanes may be listed individually to determine whether each lane comprises a suitable lot. For example, the present invention may be applied to a purchaser of transportation services that wishes to ship goods having an estimated transportation cost of five hundred thousand dollars from an origination location that is a warehouse in Pittsburgh, Pa. to multiple destination locations in Pennsylvania, Ohio, and Indiana. Those destination locations may furthermore include a single destination in Philadelphia, Pennsylvania, three destinations in Cleveland, Ohio, and five destinations in Indianapolis, Ind. and one destination in Akron Ohio.

At 210, the purchaser utilizes a threshold whereby a shipment value threshold is used to assess if a lot is viable, e.g., a shipment value of more than twenty thousand dollars or four percent worth of total shipments constitutes a viable lot. The purchaser may determine that the first lane listed in the sorted lane list, the single destination in Philadelphia, includes shipment of fifty thousand dollars worth of goods, making that lane economically viable.

Optionally at 212, the present invention may reference a database to determine how many carriers are available to transport goods in a lotted area and score their relative competitiveness. A determination may then be made as to whether the lot is viable from a competitive standpoint. If enough desirable carriers are available to operate in the lot area then that lot may be accepted as a viable final lot, whereas if fewer than a predetermined number of desirable carriers are available to operate in the lot area, then the lot may be rejected and the lanes within that lot may be redistributed within new lots. For example, the purchaser may prefer to find that ten to twenty carriers are available to provide transportation services in a route and may be willing to settle when at least three carriers that are likely to competitively price a lot are available. It should be noted that optimization of lots for quantity of goods and optimization of lots for quantity of competing carriers are separate aspects of the present invention and may be carried out in combination or separately in any desired order. Thus, in the present example wherein a lot having a single lane from Pittsburgh to Philadelphia is being considered, the purchaser finds that many carriers travel that route and so there should be more than twenty carriers willing to price or bid on the desired transportation services in that lot.

At 214, the purchaser, therefore, creates a lot including only the Philadelphia lane. The purchaser may furthermore remove the lane that has now been lotted from the lane listing or otherwise mark the lane as lotted to avoid placing a lane in more than one lot.

At 216, the purchaser recognizes that lanes remain to be lotted and returns to 208 to lot those remaining lanes. After all lanes are lotted or determined to be better left unlotted, the lotting method of FIG. 5 is completed at 218.

The purchaser may also determine that the second lane listed in the sorted list, a first Pittsburgh to Cleveland lane, has a value of thirty thousand dollars, making that lane economically viable and that more than twenty carriers are available in that lane, making that lane a viable lot. The purchaser may, therefore create a lot including only the first Cleveland lane. The purchaser may recognize that the third lane listed in the sorted lane list is worth less than a threshold, e.g., twenty thousand dollars. Thus, none of the remaining lanes are economically viable without being combined with another lane.

The purchaser may then analyze the lanes in combination by combining lanes having destinations in or near the same city. The second and third Cleveland lanes may be determined to be worth eight thousand dollars and four thousand dollars respectively. That purchaser may, however, recognize that due to the close proximity of the three Cleveland area destinations, goods may be shipped to all destination locations in Cleveland without substantially reducing competitiveness. Thus, the shipping merchant may create a Cleveland lot by adding the second and third Cleveland lanes to the lot containing the first Cleveland lane. The Cleveland lot would, therefore, have an origination area encompassing the Pittsburgh warehouse and a destination area encompassing the three Cleveland destinations.

The purchaser may also analyze the lanes destined for Indianapolis in combination. While each of those lanes is not economically viable individually, the five Indianapolis destinations may be in close proximity and, together, may have a value of more than the threshold, e.g., twenty thousand dollars and, therefore, make a viable lot in combination.

The Akron lane may have a value of five thousand dollars and be the only lane originating in Pittsburgh and having a destination in the Akron area. Thus, the purchaser may view a combination of all lanes originating in Pittsburgh and destined for Ohio. After viewing that lot, the purchaser may determine that a lot combining the three Cleveland routes and the Akron route is economically viable but will result in a high price because it requires the carrier to travel not only to three geographically proximate destinations in Cleveland, but also to a geographically disparate destination in Akron. Thus, the purchaser may opt to purchase transportation to Akron separate from Cleveland, thereby optimizing the Cleveland route at the expense of purchasing Akron transportation at a higher as needed price. Alternately, the purchaser may determine that Akron is geographically proximate enough to Cleveland to combine the Akron lane with the three Cleveland lanes. In either case, the present system could warn against or completely disallow the creation of a lot if the supply base did not meet a predetermined requirement such as, for example, a minimum number of past pricing experiences with the purchaser, the number of available carriers falls below a predetermined number, or if at least one available carrier has not placed a low bid in a previous event.

Lane analysis and lot creation at 208-216 typically involves initially examining the sorted lanes and placing large, commonly traveled lanes in separate lots. Once those lanes are lotted further lotting is performed by expanding either the geographic area covered by the origination area or the destination area to include more than one lane in the lot. For example, where a shipping merchant ships from a distribution center origination location to many destination locations, the remaining lanes may be analyzed by lanes originating in the city in which the origination location lies and destined for any location within a particular state. All such groupings that form suitable lots may then be formed into lots. That process may be repeated by expanding at least one of the origination area and the destination area covered by the lot to include even more lanes where a lot including a smaller area is still not economically viable. Thus, for example, a third iteration could include all transportation originating in or destined for a six-state region that have not been included in a preexisting lot. It should be recognized that where a great deal of goods are shipped to a small geographic area such as, for example, greater Los Angeles, it may be economically effective to create a lot for those shipments. Furthermore, where a lesser number of goods are shipped to other widely scattered areas in California, another lot may be created for all goods shipped to those scattered areas that do not include the greater Los Angeles area. In that way, transportation cost for the heavily traveled and proximately located Los Angeles lanes may be optimized by separating those lanes from the other scattered and less cost-effective lanes throughout California.

Any lanes that remain unlotted after the iterative process of increasing the origination and/or destination areas has been completed may either be included in generally large regional predefined lots such as Northeastern United States, Southeastern United States, West Coast of the United States, and Midwest of the United States, or may be held back from lotting to be purchased on an as needed basis.

In a certain embodiment of the present invention, a computer program organizes the lanes and routes containing multiple lanes into ordered groups beginning with the most active lane or route. It is known that suppliers are generally willing to supply large quantities of services for a lower price per unit than small quantities of services because large quantities promote greater efficiencies. For example, a transportation supplier can ship a full truck load of goods for a lower price per good shipped than a partial truck load. Also, a lower price per good may usually be achieved if goods are to be delivered to fewer locations. Many merchants that require transportation services, however, purchase thousands to hundreds of thousands of shipments per year making it extremely difficult to organize the shipments into cost-effective lots. Furthermore, it is known that to achieve low pricing when acquiring services, it is beneficial to have several suppliers providing competitive pricing for those services. Because there are thousands of regional carriers that operate in limited areas, however, it is difficult to lot transportation needs for many lanes into lots on which multiple carriers are willing to provide competitive pricing. Thus, the present invention may beneficially be embodied in a computer program that combines lanes into prospective lots and furthermore provides data regarding suppliers that may be willing and/or able to operate in all lanes contained in those lots.

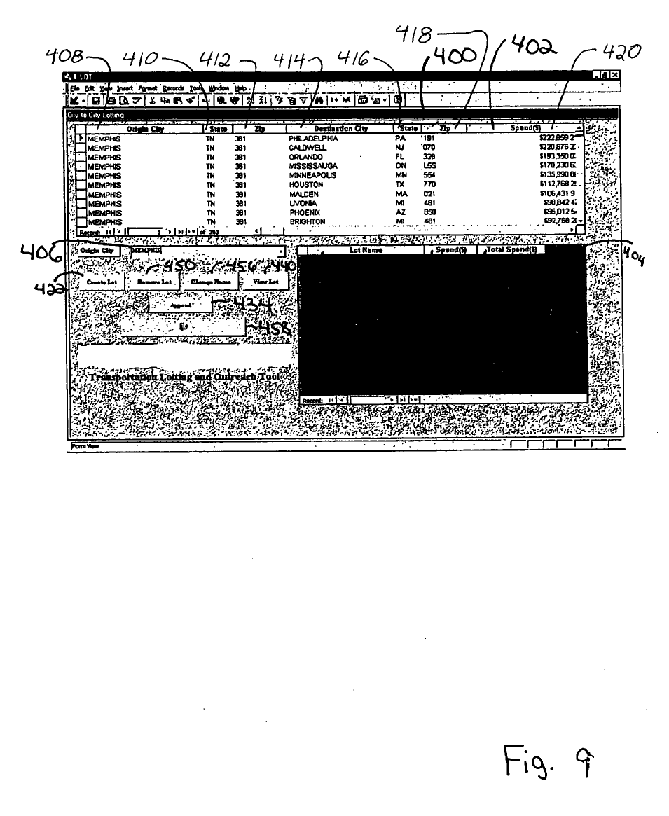

The program will typically separate the common pool of identified lanes into two or more groupings. In the first grouping the lanes are typically divided into prospective lots having small geographic areas and in the second grouping the lanes are typically divided into prospective lots having origination locations and destination locations within geographic areas larger than the small geographic areas of the first grouping. The embodiment illustrated in FIGS. 6-22 automatically groups the lanes by three geographic areas; city to city prospective lots, city to state prospective lots, and state to state prospective lots. The computer program will then separately sort the prospective lots from the largest lot to the smallest lot by volume of transportation requirements in each grouping. The program displays the sorted lots in windows for viewing by a user. The user may use the program to select lots that are suitable for pricing or bidding from the resulting prospective lot listings. For example, the user may analyze the prospective lots containing single lanes to determine whether one or more of those lots meets the user criterion for a suitable lot. The user may then select each prospective lot that is suitable to be a lot. The program may remove all lanes included in prospective lots that are selected so that those lanes are not duplicated in other lots. Once all suitable prospective lots are selected from the single lane group, the user may view the remaining lanes as grouped in the city to state group. Those city to state groupings may then be utilized or combined and utilized to create lots for lanes that were not included in the already formed lots. The state to state prospective lots may then be considered to combine lanes not lotted in either the city to city or city to state lotting process. It should be noted that certain transportation lanes may be so small in terms of quantity or cost of goods shipped or so remote from other lanes that those lanes are not included in any lots, but rather transportation needs in those lanes may be purchased on an as needed basis.

The computer program may utilize intelligence regarding carriers in selecting geographic areas to be included in prospective lot creation. As background, freight companies, for example, are typically licensed to operate by individual states and nations. Therefore, many carriers are licensed to operate only in a limited number of states or nations. Thus, when a lot encompasses lanes having origination locations or destination locations in many states or nations, there may only be a limited number of carriers capable of transporting in all of the states or nations encompassed by that lot. Furthermore, carriers may regularly transport goods to a limited area within a state or nation. For example, a carrier may be licensed to transport goods throughout the entire state of Pennsylvania, but may only travel regularly to the Philadelphia area in eastern Pennsylvania and not to the Pittsburgh area in Western Pennsylvania. Moreover, it is desirable for a shipping merchant wishing to purchase transportation services to increase the number of carriers providing pricing for each lot to increase competition between the carriers, thereby driving down the cost to the shipping merchant. Thus, the computer program may include a database of carriers along with information related to each carrier. For example, the database may list carriers, the states and nations in which those carriers are licensed to operate, specific regions in which the carriers focus, historic pricing information for each carrier and other qualitative information. The computer program may then check every prospective lot created to assure that at least a minimum number of carriers will be able to quote pricing for each lot. The pricing information may furthermore be utilized to disqualify carriers that have historically not provided competitive pricing or have provided inadequate service.

The carrier database may be acquired by researching known carriers and may be supplemented as, for example, additional information is received from shipping merchants who have experience with carriers that are not listed in the database.

Transportation lotting, or the creation of lots containing transportation services, is typically an iterative process. In that process, lots are created to encompass particular origination and destination areas and the number of potential bidders for those areas and the amount of goods to be shipped in those areas are determined. New lots having different origination and/or destination areas are created if either the number of potential bidders is so great that it is thought a smaller, more cost effective lot may be created or if too few potential bidders are identified and it is necessary to create a potentially less cost effective lot to obtain at least a desired number of potential bidders. New lots having different origination and/or destination areas are created when the quantity of goods to be transported in the lots are less than optimum as well. Thus, iterations of adjusting lot origination and destination areas may be performed until lots having optimum quantities of goods and numbers of bidders are created. Those iterations may furthermore begin with either optimization for quantity of goods or optimization for number of potential bidders. The decision as to whether to begin with optimizing quantity of goods or number of bidders may depend on many considerations including beginning with the parameter that is expected to be most difficult to satisfy.

FIG. 6 illustrates a start screen 300 for an embodiment of the present invention wherein lots are formed by regions. The start screen 300 includes facilities depicted as selectable buttons on a screen including a city to city level lotting button 302, a city to state level lotting button 304, a state to state level lotting button 306, a high level lotting export to a spread sheet button 308, an outreach form button 310, an edit service configuration button 312 and an exit application button 314. Those buttons will be described in connection with the Figures described below.

FIG. 7 illustrates an embodiment of a “city to city” lotting screen 400 having a lane window 402, a lot window 404, and an origination city pull-down menu 406. A user may begin utilizing the program illustrated in FIG. 7 by accessing the origination city pull-down menu 406.

As illustrated in FIG. 8, the program of this embodiment sorts the origination cities in the pull-down menu 406 in descending order beginning with the city having the highest value of originating shipping services and ending with the city having the lowest value of originating shipping services. The user may scroll through the list and select an origination city therefrom. The user may furthermore begin with the city from which the greatest amount of transportation will be required. It is likely that the city from which the largest shipping value or from which the largest amount of goods is shipped will also be the city from which some of the largest lanes begin. Therefore, it is likely that lanes having a great deal of goods and very small origination and destination areas may be discovered in that listing. It may be, for example, that a single lane from one location or city to another location or city qualifies as a lot, or it may be that a combination of lanes from one location or city to two or more geographically proximate locations or cities qualifies as a lot. For example, where two or more destination locations or cities are located in close proximity, those lanes may be beneficially combined. Alternately, where one or more locations or cities fall on or near a route that is likely to be taken to another location or city, those locations or cities may be beneficially combined into a lot.

FIG. 9 illustrates the city to city lotting screen of FIG. 7 in which the city of Memphis has been selected from the origination city pull-down menu 406. All routes originating in Memphis are, therefore, listed in descending order in the lane window 402. Information associated with each destination city is listed in each row and includes the name of the origination city 408, the state in which the origination city lies 410, in this example, the first three characters of the postal or zip code of the origination cities 412, city, or portion thereof from which shipments will be made, the name of the destination city 414, the state in which a destination city lies 416, the first three characters of the postal code of a destination city 418, city or portion thereof to which shipments will be made, and an amount of “spend” 420, which is a value of goods, to be shipped in that lane during the time for which pricing is sought. A user may select lanes from the lot window 404 to be included in a lot. To create a lot, a first lane to be included in the lot is selected from the lane window 402 and a create lot button 422 is selected. The term “button” as used herein indicates a facility that may be selected by, for example, being depressed or, where the facility is incorporated into a computer screen, selected by mouse, keyboard, or touchscreen or other device to perform a desired function.

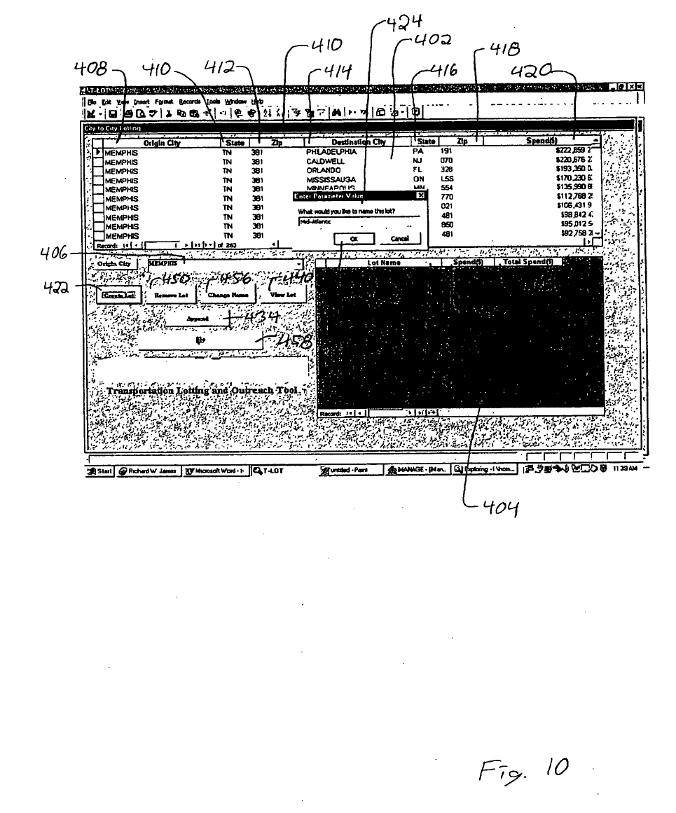

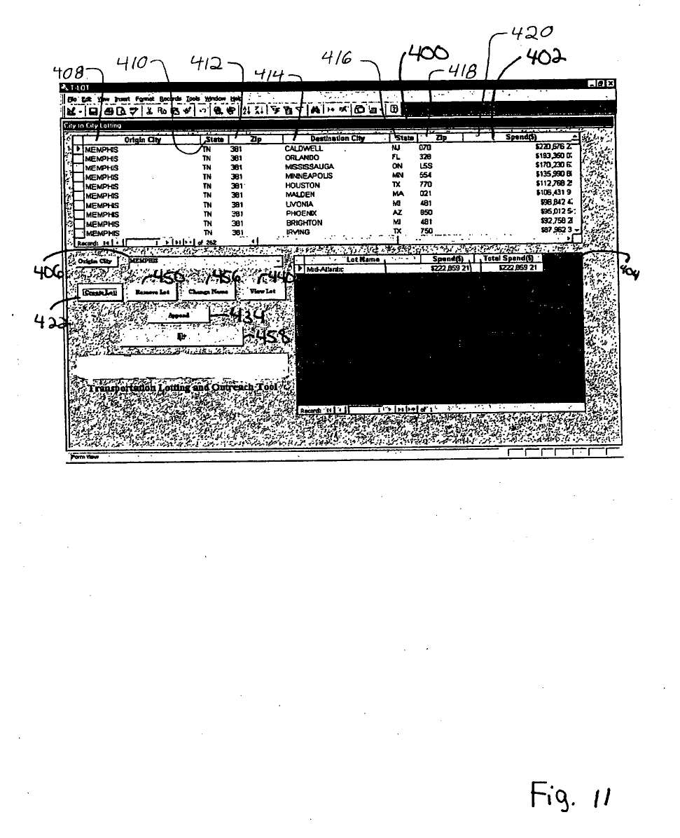

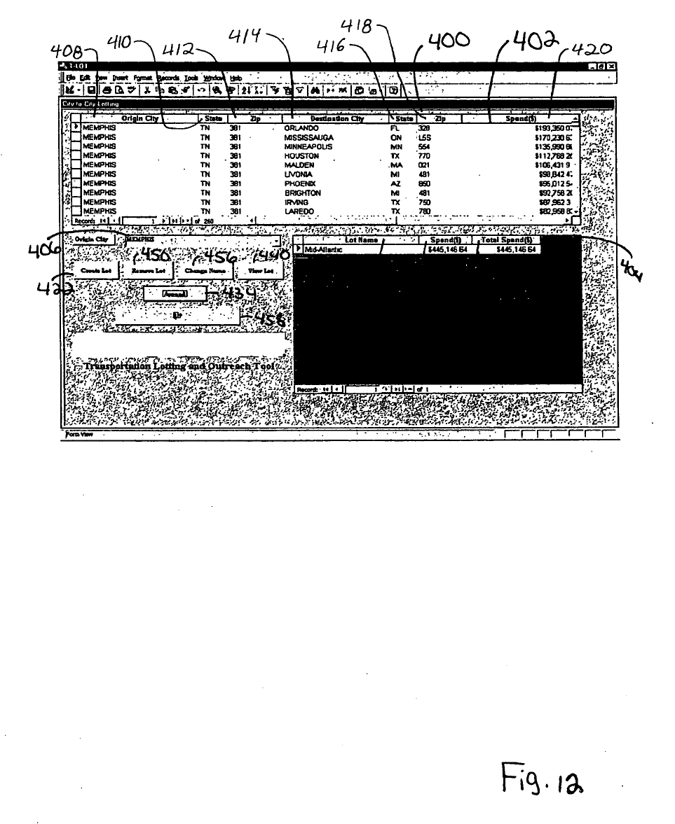

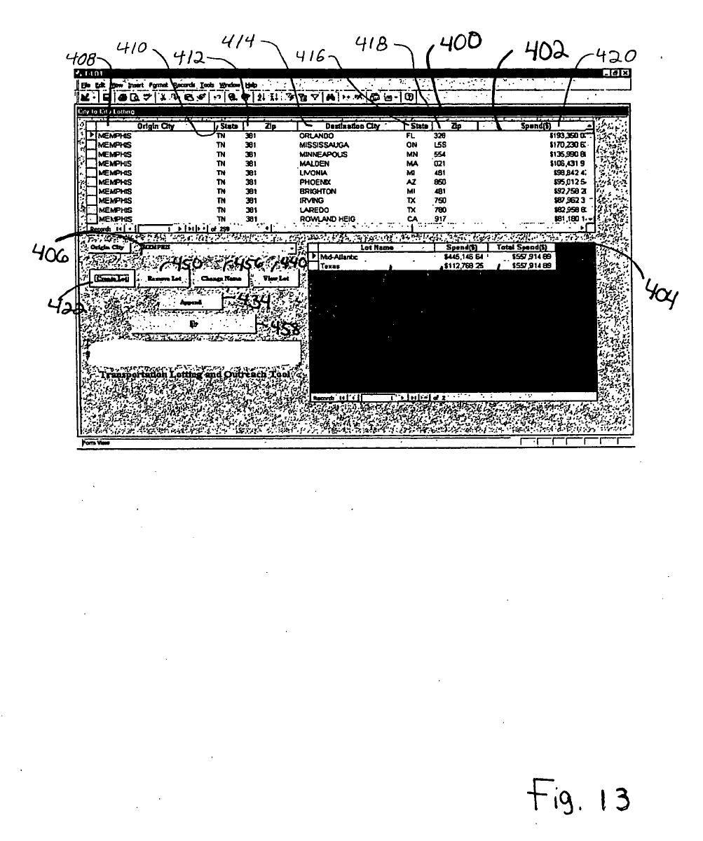

FIG. 10 illustrates the city to city lotting screen of FIG. 7 after the Memphis to Philadelphia lane has been selected from the lane window 402 and the name of the lot has been entered into a lot naming window 424 initiated by selecting the create lot button 422.

FIG. 11 illustrates the city to city lotting screen of FIG. 7 after the name of the lot has been entered and accepted by selecting an OK button 426 in the lot naming window 424. As may be seen, a lot having the name entered in the lot naming window 424 appears in a lot name column 428 of the lot window 404. The estimated transportation cost to ship goods from Memphis to Philadelphia is indicated in a spend column 430 because that lane was selected to be included in the lot. The total estimated transportation value included in all lots is indicated in a total spend column 432. To add additional lanes to a lot, the appropriate lot is selected in the lot window 404 and the lane to be added to that lot is selected in the lane window 402. An append button 434 is then selected to add the selected lane to the selected lot.

FIG. 12 illustrates the city to city lotting screen of FIG. 7 after the Memphis to Caldwell lane was added to the Mid-Atlantic lot. As is depicted in FIG. 12, the Memphis to Caldwell lane has been removed from the lane window 402 because that lane is now included in a lot and should not be placed in another lot and the spend and total spend columns of the Mid-Atlantic lot have been increased by the amount of the Memphis to Caldwell lane.

FIG. 13 illustrates the city to city lotting screen of FIG. 7 after a second lot containing the Memphis to Houston lane has been created. Creation of that lot caused the Memphis to Houston lane to be removed from the lane window 402 and the Texas lot to be created in the lot window 404.

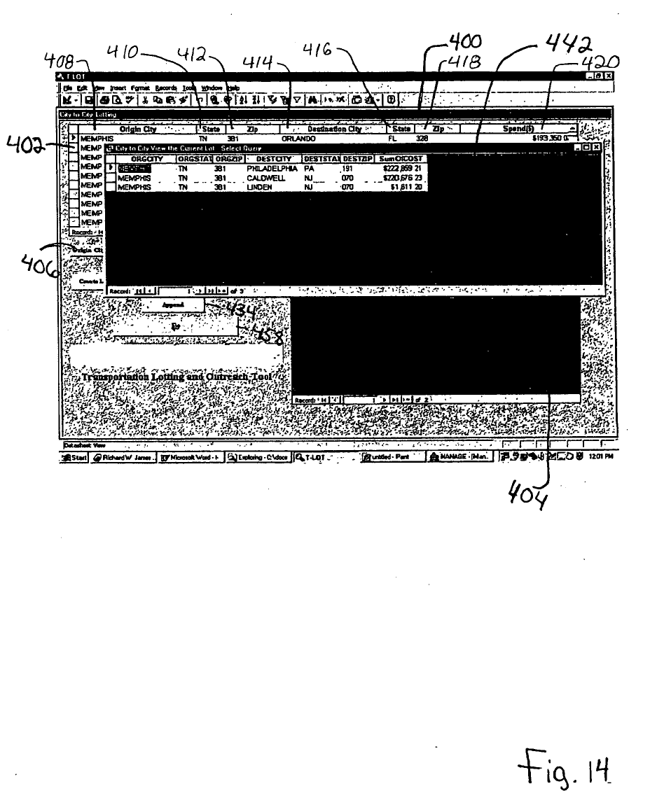

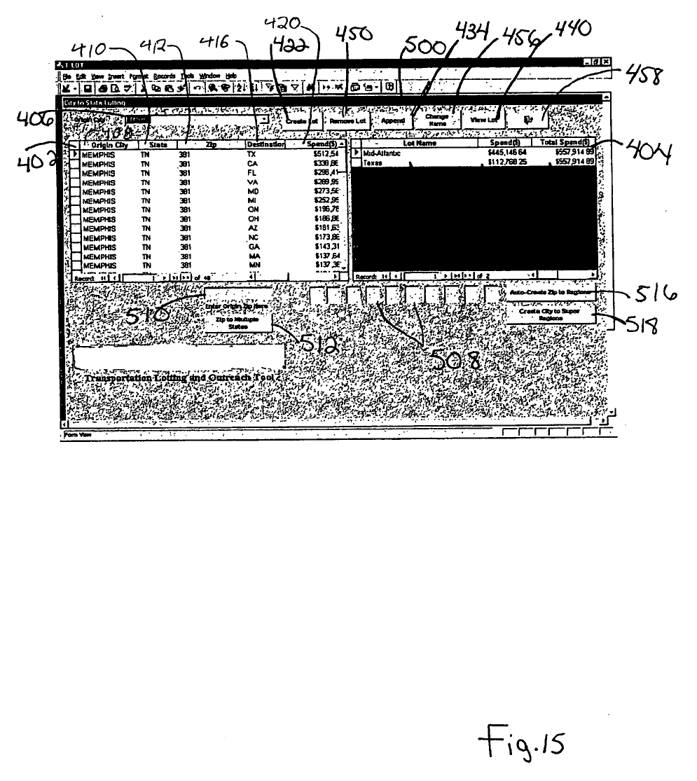

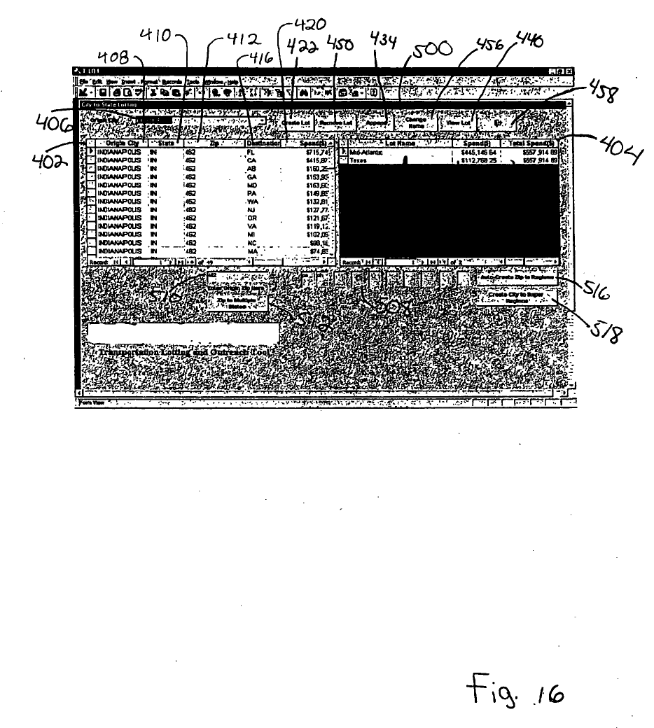

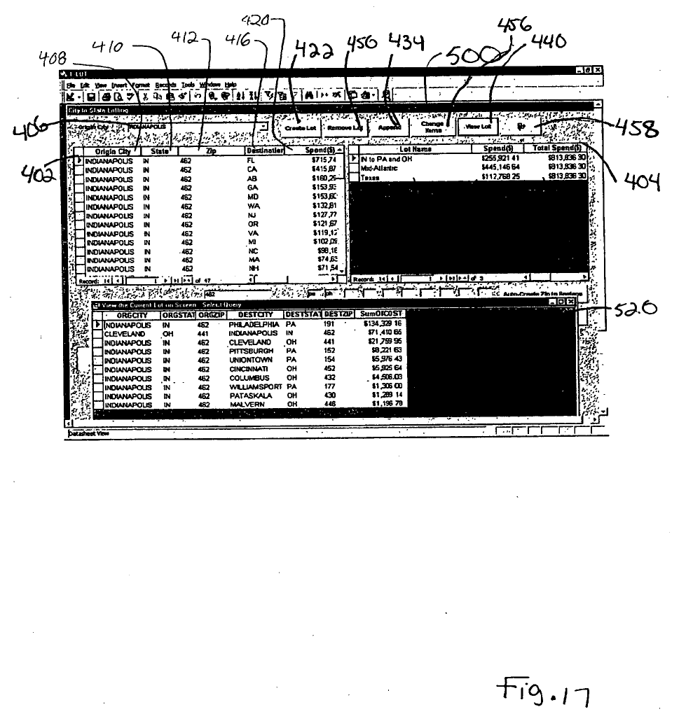

FIG. 14 illustrates the lanes that are included in the Mid-Atlantic lot. To view the lanes that are included in a lot at any time, a view lot button 440 (illustrated in FIG. 13) may be selected. When the view lot button 440 is selected, the lanes that are currently included in the lot selected in the lot window 404 are displayed in a lot detail window 442.

A remove lot button 450 may be selected if a user wishes to eliminate a lot or revise the lanes included in the lot. To utilize the remove lot button 450, a user may select a lot from the lot window 404 and then select the remove lot button 450. Upon selection of the remove lot button 450, the lot will be removed from the lot window 404 and the lanes that were included in the removed lot will be transferred back to the lane window 402 for inclusion in another lot.

To change the name of an existing lot, the lot may be selected from the lot window 404 and a change name button 456 may be selected. Selection of the change name button 456 causes a window to appear that asks the user for a new narne. The user may then enter the new name for the selected lot and select an OK button to replace the existing lot name with the new lot name.

When all city to city lanes that fit into efficient lots have been lotted, the user may select a close form button 458 to close the city to city lotting screen 400 and return to the start screen 600 illustrated in FIG. 6. The user may then increase the geographic area included in either the origination area or the destination area or both and thereby lot lanes that were not included in the city to city lots. In this embodiment, lots and lanes that have been defined in the lane window 402 and lot window 404 of the city to city facility or screen remain defined in other facilities or screens that consider lotting in larger geographic areas. Thus, the Mid-Atlantic and Texas lots that were created in the city to city facility are defined when a user switches to other facilities that contemplate lotting in larger geographic areas. Moreover, the lanes that are included in the lots defined in the city to city facility are not listed in the lane window 402 of other facilities that contemplate lotting in larger geographic areas so that the lanes will not be duplicated in other lots.

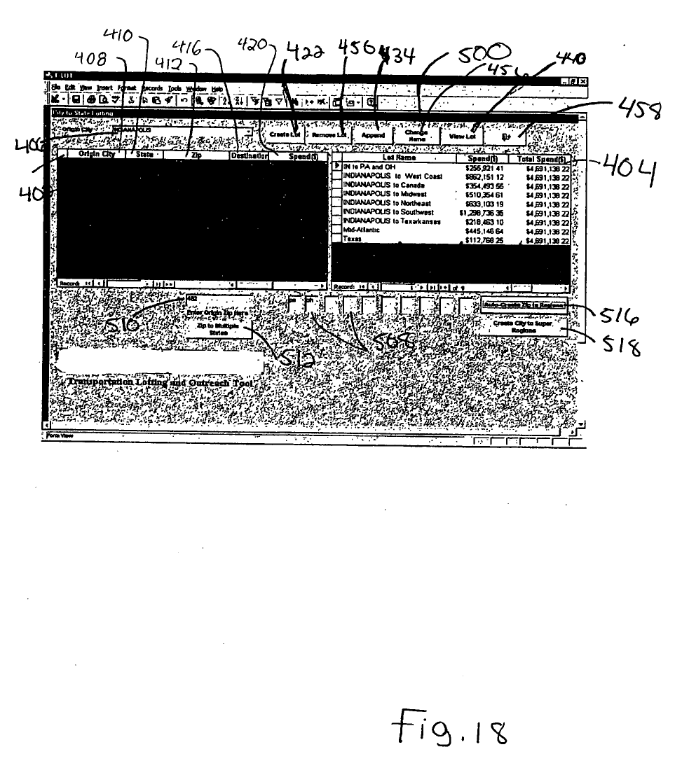

Referring again to FIG. 6, after all city to city lotting has been completed, the user may define city to state lots containing lanes not yet assigned in city to city lots by selecting the city to state button. FIG. 15 illustrates the city to state lotting screen 500. In the city to state lotting screen 500, the origination city pull-down menu 406, create lot button 422, remove lot button 450, append button 434, change name button 456, view lot button 440 and close form button 458 operate as described in connection with the city to city lotting screen 400. The lane window 402 and lot window 404 also operate similar to the lane and lot windows 402 and 404 in the city to city lotting screen 400, and the information contained in those windows are updated in a single database regardless of which facility (i.e., the city to city facility, the city to state facility, or the state to state facility to be described hereinafter) is being utilized.

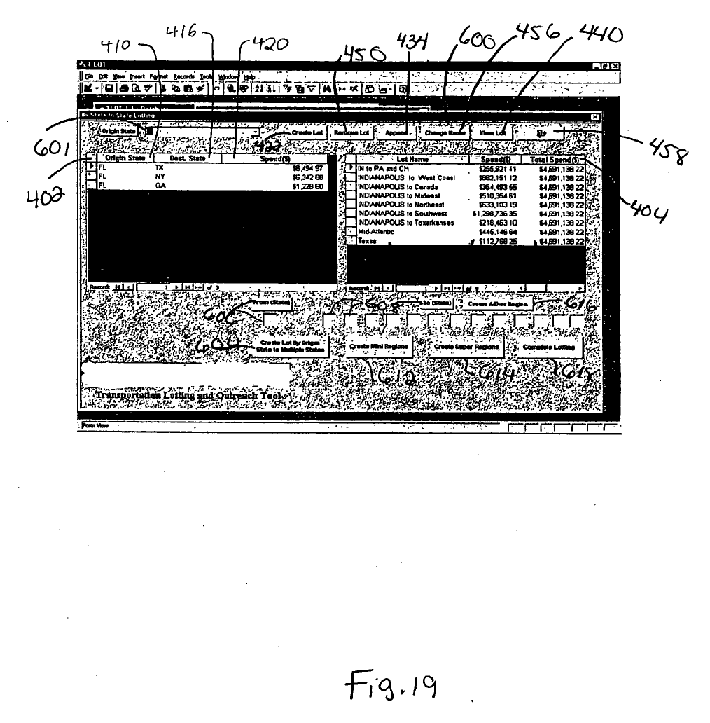

FIG. 16 illustrates the city to state lotting screen 500 of FIG. 15 wherein another lotting strategy is utilized. City to state lotting may also be performed in the city to state lotting screen 500 by placing a postal code of the cities, city, or city portion in which the desired origination location lies in an origination postal code dialog box 510 and abbreviations for desired destination states are entered in destination state dialog boxes 508. The embodiment illustrated includes ten state dialog boxes, but it will be recognized that any number of states may be considered using the present invention. Furthermore, for territories outside the United States, location indicators other than postal or zip code may be utilized and states may include nation states, territories within those nations, or any predefined territory. Once the origination and destination territories (origination zip code and destination states) have been selected in the embodiment illustrated, a zip to multiple states button 512 may be selected. Selection of that button 512 will cause the program to create a lot including all lanes originating at the origination location designated in the origination postal code dialog box 510 and destined for the destination states designated in the destination state dialog boxes 508.

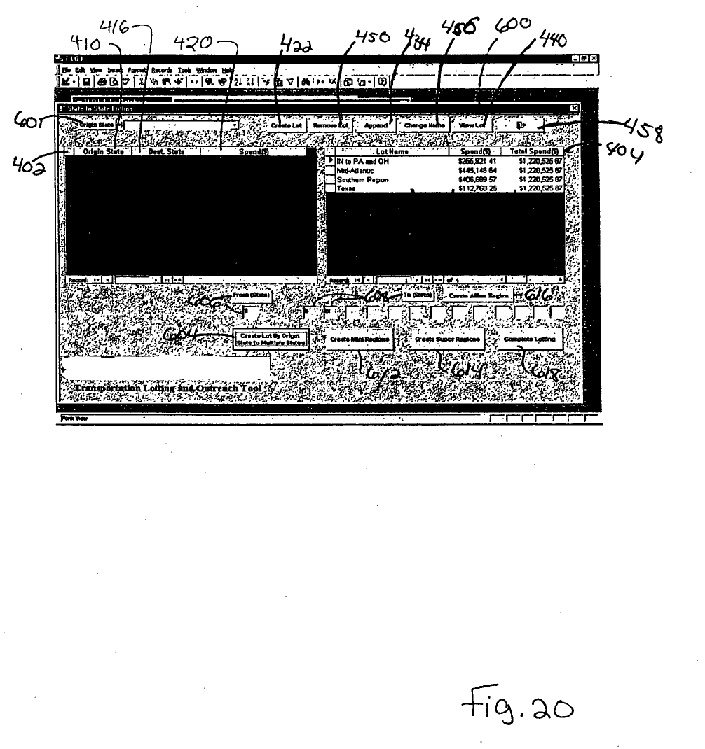

FIG. 17 illustrates the city to state lotting screen 500 of FIG. 15 after a lot having the Indianapolis, Ind. zip code beginning with 462 as an origination location and all Pennsylvania and Ohio destinations from that origination location as a destination area. As may be seen by reference to FIG. 17, the 462 zip code was entered in the origination postal code dialog box 510 and the abbreviations for Pennsylvania and Ohio were entered in two of the destination state dialog boxes 508. The zip to multiple states button 512 was then selected to create the lot and the view lot button 440 was selected to display the lanes that are included in that lot in a view current lot window 520 displayed in the lower portion of the screen. It may also be noted that a lane originating in Ohio and destined for Indianapolis is included in the listed lanes. It will be recognized that that lane originates in a state listed as a destination in the destination state dialog boxes 508 and is destined for the city designated in the origination postal code dialog box 510. Such reverse lanes are also listed because those lanes are often economically viable in combination with lanes operating in the opposite direction as return lanes.

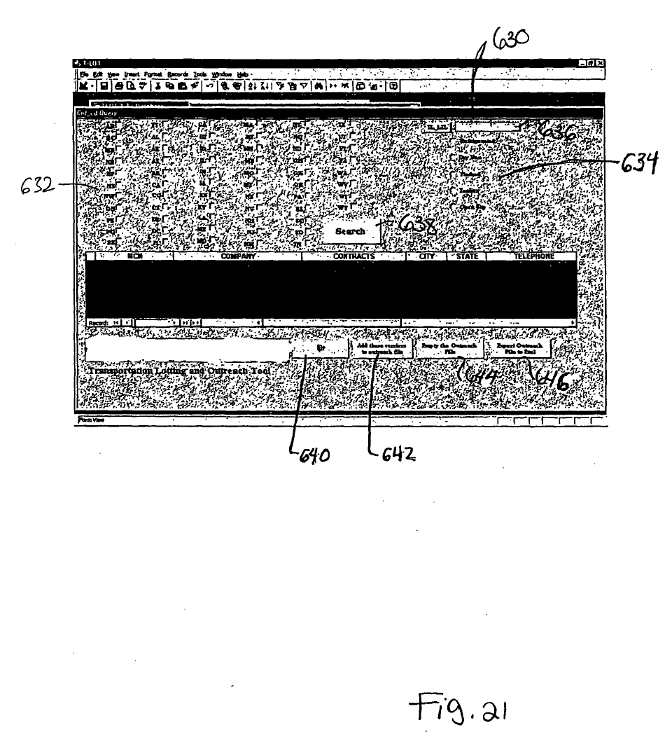

FIG. 18 illustrates the city to state lotting screen 500 of FIG. 15 after an auto create zip to regions facility has been executed by selecting the button 516 of the same name. The auto create zip to regions facility 516 takes all lanes listed in the current lane window 402 and assembles those lanes into lots by a predefined destination region. Thus, in the example depicted, all lanes originating in Indianapolis that were not previously lotted have been lotted into lanes destined for the West Coast, lanes destined for Canada, lanes destined for the Midwest, lanes destined for the Northeast, lanes destined for the Southwest, and lanes destined for the Texarkansas area.

The create city to super regions facility 518 operates to group lanes into lots falling within predefined super regions.

Referring again to FIG. 6, after all city to state lotting has been completed, the user may define state to state lots containing lanes not yet assigned in city to city lots or city to state lots by selecting the state to state button. FIG. 19 illustrates the state to state lotting screen 600. In the state to state lotting screen 600, the origination state pull-down menu 601 operates like the city pull-down menu but groups lanes by the state in which they originate. The create lot button 422, remove lot button 450, append button 434, change name button 456, view lot button 440 and close form button 458 of the state to state lotting screen 600 operate as described in connection with the city to city lotting screen 400. The lane window 402 and lot window 404 also operate similar to the lane and lot windows 402 and 404 in the city to city lotting screen 400 and the information contained in those windows is updated in a single database regardless of which facility is being utilized. The state to state lotting screen 600 combines lanes listed in the lane window 402 such that all lanes that originate in a particular state and are destined for another particular state are combined into single lots. Those state to state lanes may, therefore be combined into lots by selecting the desired lane and creating a lot as described previously.

FIG. 20 illustrates a Southern lot created by selecting Florida as the origination state and Louisiana and Texas as destination states through the state to multiple state facility included in the state to state screen 600. The state to state lotting screen provides that ability to create a lot originating in one origination state and destined for multiple states. To automatically create state to multiple state lots, the user may enter a state abbreviation in an origination state dialog box 606 and multiple destination states in destination state dialog boxes 608. Once all desired states have been entered, the user selects a create lot by origination state to multiple states button 604. The create lot by origination state to multiple states facility combines all lanes that have not yet been lotted and that originate in the state identified in the origination state dialog box 606 and that are destined for one of the states listed in the destination state dialog boxes 608. Thus, in the example depicted, all lanes originating in Florida and destined for either Texas or Georgia that were not previously lotted will be placed in a lot when the create lot by origination state to multiple states button 604 is selected.

The create mini regions facility 612 and create super regions facility 614 operate to group lanes that do not fit well into city to city, city to state, or state to state lots into lots that lie within predefined regions. The create ad-hoc region facility 616 may be utilized to combine lanes having origination and destination locations that do not fall within the predefined areas.

The complete lotting facility 618 places lanes not falling within any of the city to city, city to state, state to state, mini regions or any other predefined geographic area into one or more lots. A lot created by the complete lotting facility 618 may, for example, place all remaining lanes in a lot encompassing the entire United States or a multinational region.

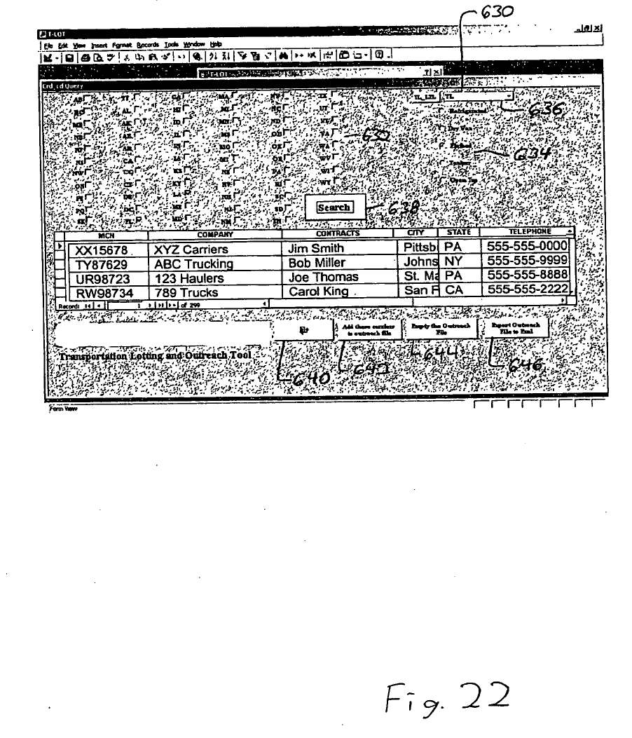

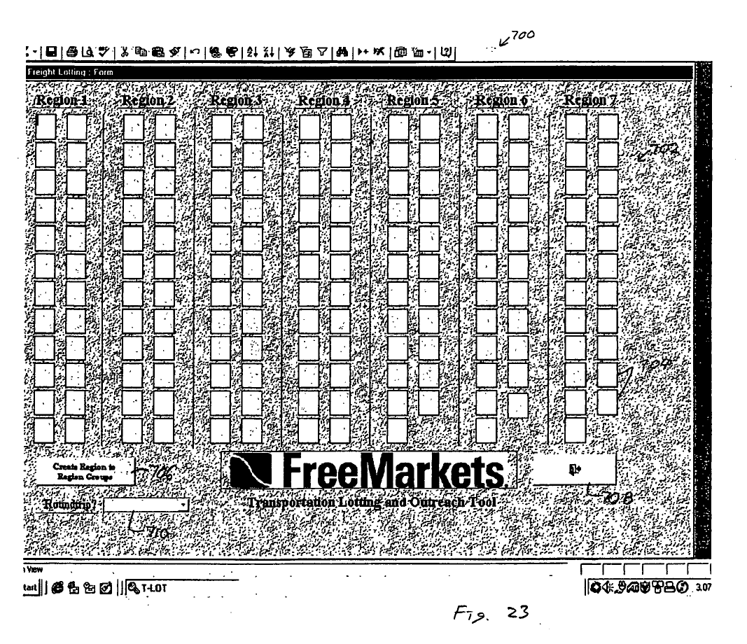

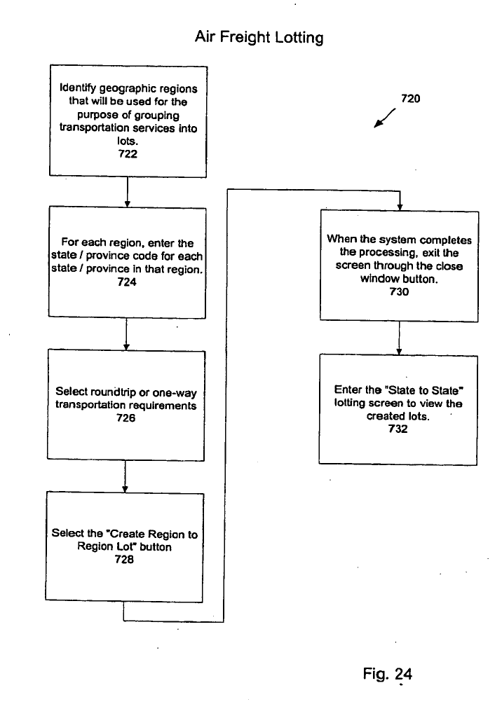

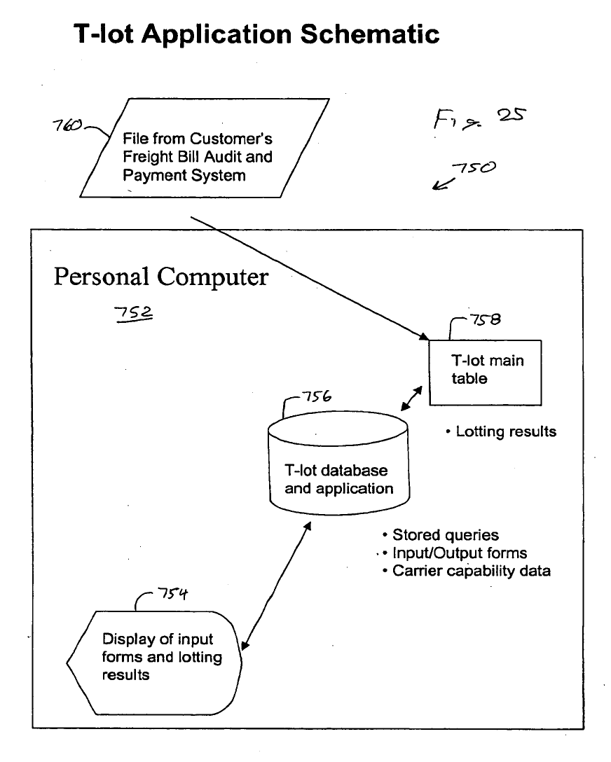

FIG. 21 illustrates an outreach screen 630 that may be accessed by selecting the outreach form button 310 of FIG. 6. The outreach screen 630 permits a user to determine which carriers included in a database are licensed to operate in a lotted area. To use the outreach facility, a user may select the states or territories included in the lot by selecting a box next to an abbreviation for that state or territory in the territory area 632. The user may also select the type of transport desired from the transportation type area 634. The types of transport listed in FIG. 22 include types of truck transport, but could include any type of transport. In addition, the user may select truck load, abbreviated as TL, and/or less than truckload, abbreviated as LTL shipping from the TL-LTL pull-down menu 636. Once the territory area 632, transport type area 634, and TL-LTL pull-down menu 636 have been completed, the user may select the search button 638 and will be provided with a listing of carriers from the database that are able to provide the required transportation services.

FIG. 22 illustrates the outreach screen 630 wherein Texas, Louisiana, and Florida are included in the territory area, and flatbed transport and TL shipping are desired. The selection of territories such as Texas, Louisiana, and Florida, type of transport such as flatbed, and type of shipping such as truckload shipping, filters carrier data when the search button 638 is selected. The outreach screen 600 lists potential carriers and information related to those carriers including, for example, the home location and contact information for each carrier in a carrier database that may be a temporary file. The outreach screen 600 includes a close form button 640 to return the user to the start screen 600 illustrated in FIG. 6. An add these carriers to outreach button 642 is also included on the outreach screen 600 and may be selected to facilitate adding carriers to the carrier database that contains a listing of carriers filtered by the selected parameters such as territory, transport, and shipping type. An empty the outreach file button 644, for removing all carriers from the carrier database, is also included on the outreach screen 600. Furthermore, the outreach screen 600 includes an export outreach file to excel button 646 to export the carrier listing of the carrier database to a spreadsheet for manipulation or display through the spreadsheet, or for saving for future use. The invention illustrated in the outreach screen 630 of FIG. 22 may be utilized to create a cumulative listing of all carriers that may service any one or more lot of transportation services.

FIGS. 23 and 24 illustrate an embodiment of the present invention in which air freight is lotted. FIG. 23 illustrates a regional lotting form 700. The regional lotting form 700 depicted includes space for creation of seven regional lots 702, however, any desired number of regions may be accommodated by the present invention. Each of the regional spaces furthermore includes a plurality of geographic identification dialog boxes 704. A geographic area identifier such as a state or providence code may be entered in each of the geographic identification dialog boxes 704. A round trip pull down menu 710 is also included on the regional lotting form 700 and permits a user to select either round trip or non-round trip transportation requirements for each of the regions.

A create region to region groups facility 706 is included in the region to region lotting form 700 and may be selected to create regions once the geographic identification dialog boxes 704 have been completed for each desired region. The create region to region groups facility, which may be a button on a screen selectable by a computer mouse, may operate with the geographic area identifiers in each region to create each permutation of every defined region to every other defined region to form lots automatically. For example, all lanes moving from region 1 to region 2, from region 1 to region 3, and from region 2 to region 3, etc., may be pulled from the shipment data to constitute a single lot, assuming one-way rather than round trip transport has been selected. If, alternately, roundtrip transport is selected, lanes moving from region 1 to region 2 and lanes moving from region 2 to region 1, for example, may be pulled from the shipment data to constitute a single lot.

A close form button 708 may be utilized to close the regional lotting form 700 after regions have been identified.

FIG. 24 is an air freight lotting flow chart 720 indicating a method of using the regional lotting form 700. At 722, geographic regions that will be utilized for lotting of transportation services are identified. At 724, a geographic area identifier for each area to be included in a region is entered into the geographic identification dialog box 704 of the desired region. It should be noted that not every geographic identification dialog box 704 in a region need be filled and that any number of geographic areas may be included in a region. After all of the geographic area identifying codes are entered in the desired regions, the round trip pull down menu 710 may then be utilized to indicate whether transportation services in the identified regions are round trip needs or one-way needs, at 726. At 728, the create region to region groups facility may be selected by, for example, clicking on a button displayed on a screen with a mouse to create the desired regions. After the regions have been created, the closed form button 708 may be selected at 730 to close the regional identification form 700 and return the user to the start screen 600 illustrated in FIG. 6. At 732, the user may enter the state to state lotting screen which has been described hereinbefore to view the created lots of lanes which are included in each of the regions created. It should be noted that although the use of the regional lotting form 700 has been described in connection with air freight lotting, that form may alternately be used to create regions for lotting any type of freight regardless of the type of transport.

FIG. 25 illustrates a transportation lotting application schematic 750. The transportation lotting application schematic 750 includes a personal computer 752 that may execute the present invention. Alternately, any processor type may be utilized to execute the present invention. The personal computer 752 may include a display 754 which may display input forms and lotting results for the present invention. The personal computer 752 may also include a storage facility 756 in which the transportation lotting databases an executable application may be stored. The personal computer 752 may also include a transportation lotting main table 758 that includes lotting results. Furthermore, transportation requirements may be downloaded to the personal computer 752 from a customer database, such as a freight bill audit and payment system 760.

While the invention has been described in detail and with reference to specific embodiments thereof, it will be apparent to one skilled in the art that various changes and modifications can be made therein without departing from the spirit and scope thereof. In particular, it should be noted that while the transportation lotting functions described above have been described in the context of utilizing trucking for transport and wherein the lots are utilized in a downward pricing (reverse) auction, any type of transport may be considered utilizing the present invention and the auction functions can be equally applied to upward pricing (forward) auctions. Thus, it is intended that the present invention cover the modifications and variations of this invention provided they come within the scope of the appended claims and their equivalents.

1. A system for grouping transportation lanes included in a plurality of transportation lanes, wherein each transportation lane in the plurality of transportation lanes includes an origination location and a destination location and each transportation lane in the plurality of transportation lanes has an associated transport value, comprising:
a processor; and
a memory coupled with the processor, wherein the memory is configured to provide the processor with instructions which when executed cause the processor to:
create an origination area;
create a destination area;
compile into a lot all lanes in the plurality of transportation lanes having origination locations falling within the origination area and destination locations falling within the destination area;
determine the number of carriers available to operate in a lot area comprising the origination area and the destination area; and
store the lot if it is determined that at least a predetermined number of carriers are available to operate in the lot area.

2. The system of claim 1 wherein the memory is further configured to provide the processor with instructions which when executed cause the processor to compile a list of carriers operating in the origination area and the destination area.

3. The system of claim 1, wherein the origination location is a facility.

4. The system of claim 1, wherein the origination location includes a zone defined by a US postal system code.

5. The system of claim 1, wherein the origination location includes at least one of a city, a state, and a nation.

6. The system of claim 1, wherein the origination location includes a predefined geographic area.

7. The system of claim 1, wherein the destination location is a facility.

8. The system of claim 1, wherein the destination location includes a zone defined by at least a portion of a US postal system code.

9. The system of claim 1, wherein the destination location includes at least one of a city, a state, and a nation.

10. The system of claim 1, wherein the destination location includes a predefined geographic area.

11. The system of claim 1 wherein the memory is further configured to provide the processor with instructions which when executed cause the processor to sort the lanes by a value of transportation in each lane.

12. The system of claim 1 wherein the memory is further configured to provide the processor with instructions which when executed cause the processor to store the lanes in a database.

13. The system of claim 1, wherein the lot is a first lot and wherein the memory is further configured to provide the processor with instructions which when executed cause the processor to remove each lane included in the first lot from a database of available transportation lanes to avoid placing lanes included in the first lot into a second lot.

14. The system of claim 1 wherein the memory is further configured to provide the processor with instructions which when executed cause the processor to create a plurality of lots, collectively including all lanes in the plurality of transportation lanes

15. The system of claim 1, wherein the transport value is an estimated cost of transporting goods in the lot.

16. The system of claim 1, wherein the transport value is a quantity of goods to be transported in the lot.

17. The system of claim 1, wherein the lot is created for use in an online auction.

18. The system of claim 1 further comprising redistributing the lanes within a plurality of other lots if it is determined that fewer than the predetermined number of carriers are available to operate in the lot area.

19. A method of grouping transportation lanes included in a plurality of transportation lanes, wherein each transportation lane in the plurality of transportation lanes includes an origination location and a destination location and each transportation lane in the plurality of transportation lanes has an associated transport value, comprising:
creating an origination area;
creating a destination area;
compiling into a lot all lanes in the plurality of transportation lanes having origination locations falling within the origination area and destination locations falling within the destination area;
determining with a processor the number of carriers available to operate in a lot area comprising the origination area and the destination area; and
storing the lot if it is determined that at least the predetermined number of carriers are available to operate in the lot area.

20. A computer program product for grouping transportation lanes included in a plurality of transportation lanes, wherein each transportation lane in the plurality of transportation lanes includes an origination location and a destination location and each transportation lane in the plurality of transportation lanes has an associated transport value, the computer program product being embodied in a computer readable medium and comprising computer instructions for:
creating an origination area;
creating a destination area;
compiling into a lot all lanes in the plurality of transportation lanes having origination locations falling within the origination area and destination locations falling within the destination area;
determining the number of carriers available to operate in a lot area comprising the origination area and the destination area; and
storing the lot if it is determined that at least the predetermined number of carriers are available to operate in the lot area.
